(19) United States
(12) Patent Application Publication
(10) Pub. No.: US 2008/0267698 A1
(43) Pub. Date: Oct. 30, 2008

(54) QUICK-CONNECTOR FOR METALWORKING TOOL AND METHOD THEREFOR

(76) Inventors: Charles Rinkenberger, Morton, IL (US); Gerald Argadine, Delavan, IL (US); Kent Mettelmann, Groveland, IL (US)

Correspondence Address: BRINKS HOFER GILSON & LIONE, P.O. BOX 10395, CHICAGO, IL, 60610, US

(21) Appl. No.: 11/741,915

(22) Filed: Apr. 30, 2007

(51) Int. Cl. F16B 7/00

(52) U.S. Cl. 403/322.2

(57) ABSTRACT

A quick-connection device is provided for use in quickly connecting and disconnecting a tool from a machine. The device includes a detent mechanism between a tool-side portion and a machine-side portion. Advancing or retracting a sleeve will engage or disengage the detent mechanism, and the sleeve is biased into a detent-engaged position. The device includes a sleeve-retention mechanism configured to hold the sleeve in a detent-disengaged position.

### FIELD OF THE INVENTION

The present invention relates to a device for quickly connecting and releasing components of metalworking tooling.

### BACKGROUND

Tubing of various sizes may be used in a variety of applications from smaller diameter and/or thin-walled tubing used in, for example, exhaust pipes of motor vehicles to larger diameter and/or thick-walled tubing used in, for example, plumbing or construction of tubular frames. Bending machines used to place one or more bends in tubing with diameters ranging from less than two inch to greater than seven inches are well known in the art. A generic example of one such machine is described with reference to FIGS. 1-1D. FIG. 1 shows a diagrammatically-illustrated bending machine 100. The bending machine 100 includes a hydraulic, electric, or hybrid motor and controller apparatus 102 that provide controlled operative force to a bending mechanism 104, which is shown in greater detail in FIGS. 1A-1D.

FIG. 1A shows a partially exploded view of the bending mechanism 104, which includes a generally cylindrical mandrel 106 having a semi-flexible distal end portion 106a (usually including several rings or plates having an outer diameter substantially the same as the main mandrel body), a wiper die 108, a bend die 110, a clamp die 112, and a pressure die 114. Each of the die components includes a concave internal radius: wiper die radius (not shown), bend die radius 110a, clamp die radius 112a, and pressure die radius 114a. Those of skill in the art will appreciate that the outer diameter of the mandrel 106 and the internal radii of the dies 108, 110, 112, 114 are configured to interact in snug contact with a tube 120 to be bent (see FIGS. 1C-1D). In this manner, and preferably with lubricant provided between contacting surfaces, a tube 120 may be bent without damaging the tube, for example, by avoiding introduction of cracks or wrinkles thereto. This is illustrated with reference to FIG. 1B, which shows a transverse cross-sectional view of the assembled apparatus 104 along line 1B-1B of FIG. 1A.

FIGS. 1C-1D show a partial longitudinal section view (along line 1C-1C of FIGS. 1A and 1B) of a bending mechanism 104 assembled and actuated during successive stages of a bending operation to bend a tube 120 (which is shown in dashed lines). As is shown in FIG. 1C, the tube 120 is coaxially disposed around the mandrel 106, the distal end portion 106a of which is disposed within the tube 120 and between the bend die radius 110a and clamp die radius 112a. The mandrel 106 is threadedly attached at its proximal end to a mandrel-mount shaft 118, which secures the mandrel 106 and provides a means for longitudinally aligning it (106) for use during a bending operation. Then, as shown in FIG. 1D, bend die 110 is pivoted at a 90° angle relative to the longitudinal axis of the tube 120 and mandrel 106. The clamp die 112 is correspondingly rotated to keep the tube 120 clamped between the bend die radius 110a and clamp die radius 112a. The semi-flexible distal end portion 106a of the mandrel 106 supports the tube 120 such that its (120) inner and outer diameters are not adversely affected during the bending operation.

Different sized dies and mandrels are used interchangeably on typical bending machines. The changeover procedure between these bending mechanism components presents several problems with respect just to removing and replacing a mandrel. In existing bending machine systems known and used in the art for decades, the mandrel is attached to the mandrel-mount shaft by a threaded connection. Each mandrel is relatively heavy—weighing from about a dozen to a couple hundred pounds. In order to install a mandrel, the user must properly align the threaded surface of the mandrel with a complementarily threaded surface of the mandrel-mount shaft, and then use his/her hands, a wrench, and/or a chain vise to rotate the mandrel about 30-80 times to complete a secure threaded engagement (this will vary along with the length of the threaded surfaces, as well as the length of different mandrels and the number of movable components in the distal semi-flexible region of the mandrel). As previously noted, the mandrels are lubricated during use, and residual lubricant can present challenges with handling and rotating the mandrel efficiently to fully engage it with the mandrel-mount shaft. Even though a crane or other device may be used to support the weight of the mandrel, the repetitive motions required present ergonomic disadvantages for the user when removing one mandrel and installing another mandrel. In addition, the time consumed for both installation and the reverse procedure of removing a mandrel for replacement presents an inefficiency that adversely impacts productivity and profitability of a bending operation. For example, in one review of workplace procedures, a mandrel exchange using the existing prior art threaded connection system takes about 8.7 minutes. Specifically, it takes about 8.7 minutes for an experienced user to remove a first mandrel and replace it with a second mandrel.

Therefor, there is a need for means to improve the efficiency of a mandrel exchange operation for a bending machine.

### BRIEF SUMMARY

Embodiments of the present invention meet the above described need for efficiently exchanging a mandrel. In one aspect, the present invention includes a mandrel quick-change device or chuck configured to reduce the time and effort required to exchange a first mandrel for a second mandrel on a bending machine. For example, implementation of a quick-change mandrel connector of the present invention may reduce by about four minutes the amount of time required by an experienced user to remove a first mandrel and replace it with a second mandrel. Those of skill in the art will appreciate that the quick-change device of the present invention will be readily adaptable to other metalworking tasks using similar components. For this reason, the terms “bending machine” and “mandrel” as used in conjunction with the present invention are intended to encompass other metalworking tools, and especially similar metalworking tools such as, for example, those used in longitudinal pulling/stretching of tubing or wire. Specifically, the term “bending machine” as used in conjunction with the present invention is intended to encompass any metal-working machine, other than a drill, used with a heavy tool end such as a mandrel, and the term “mandrel” as used in conjunction with the present invention is intended to encompass any heavy tool end used with a metal-working machine other than a drill. The connectors of the present invention are not configured for use with the quick-release tool ends associated with pneumatic tools such as, for example, a pneumatic impact wrench.

A quick-connector device configured for use in connecting a mandrel with a metal-working machine, said device comprising: a first portion configured for connection to a selected one of a mandrel and a metal-working machine; a second portion configured for connection to the other of the mandrel and the metal-working machine; wherein the first portion comprises a generally cylindrical first body including a first threaded surface configured for threadedly engaging the selected one of the mandrel and the metal-working machine and a detent-grooved projection at an end of the first body that is opposite the first threaded surface, said detent-grooved projection comprising a generally circumferential detent groove; and wherein the second portion comprises a generally cylindrical second body including a second threaded surface configured for threadedly engaging the other of the mandrel and the metal-working machine; a tubular sleeve slidably disposed about the second body; said sleeve having a first inner circumferential portion and a second inner circumferential portion; wherein the first inner circumferential portion has a greater diameter than the second inner circumferential portion and is longitudinally adjacent thereto; said sleeve being biased toward the second inner circumferential portion; said cylindrical second body also comprising a retention groove, at least a portion of said groove being transverse to a longitudinal axis of the cylindrical second body; said tubular sleeve comprising a pin member protruding therefrom and slidably engaging the retention groove; a cavity in the cylindrical second body end that is opposite the second threaded surface, said cavity being dimensioned to receive the detent-grooved projection; at least one detent channel open between the sleeve and the cavity; a detent member disposed movably in the at least one detent channel and dimensioned such that the detent member protrudes into the cavity when contacted by the sleeve.

A quick-connector device comprising: a tool-side element and a machine-side element; wherein the tool-side element comprises a distal means for connection to a tool and a proximal means for connection to the machine-side element; wherein the machine-side element comprises a proximal means for connection to a machine and a distal means for connection to the tool-side element; wherein one of the distal means for connection to the tool-side element and the proximal means for connection to the machine-side element comprises a slidable, longitudinally-biased sleeve member and a means for retaining the longitudinally-biased sleeve member in a position opposing its bias.

### BRIEF DESCRIPTION OF THE DRAWINGS

FIG. 1 is a diagrammatically illustrated bending machine;

FIG. 1A is an exploded view of a bending mechanism;

FIG. 1B is a partial sectional view of the bending mechanism of FIG. 1A;

FIGS. 1C-1D show an operation of the bending mechanism of FIG. 1A;

FIG. 2 is an exploded view of a mandrel connector embodiment of the present invention, shown with a mandrel;

FIG. 2A shows a mandrel-end portion of the mandrel connector embodiment, assembled to a mandrel;

FIG. 3 is an exploded view of a machine-end portion of the mandrel connector embodiment;

FIG. 3A shows a longitudinal section view of an assembled machine-end portion of the mandrel connector embodiment;

FIG. 3B shows a side view of an assembled machine-end portion of the mandrel connector embodiment; and

FIGS. 4A-4D show a method of use for a mandrel connector embodiment.

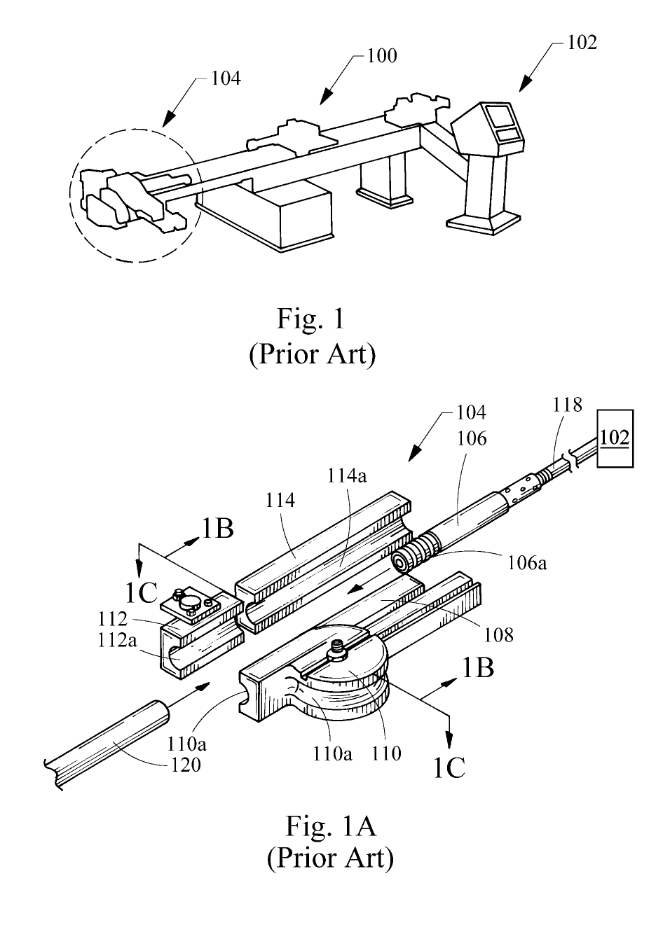

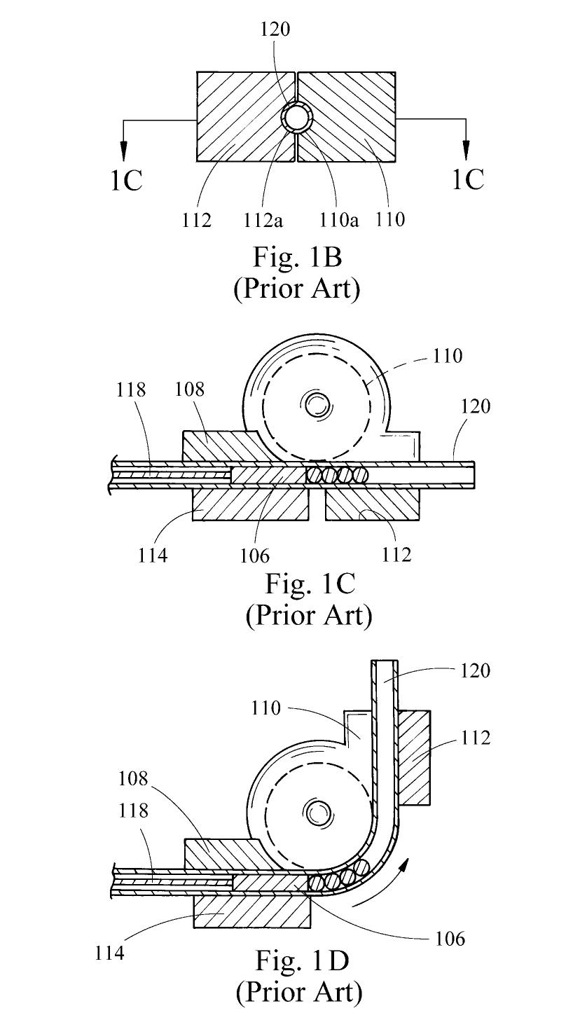

### DETAILED DESCRIPTION

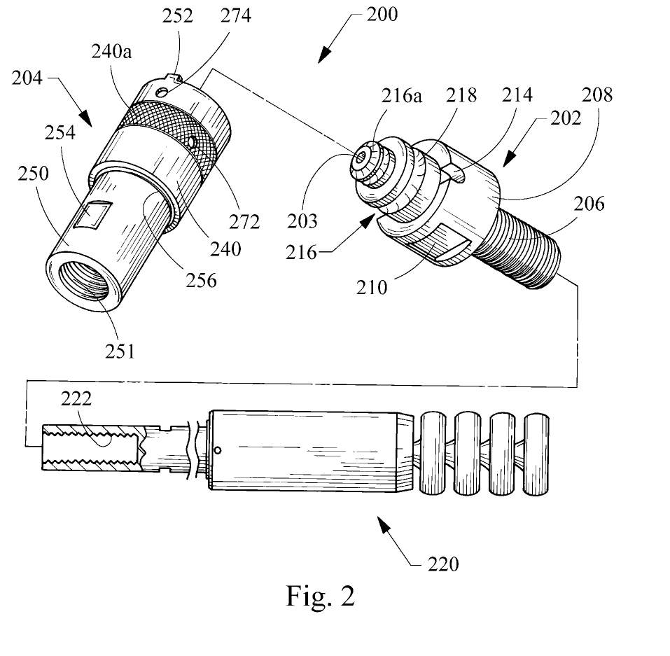

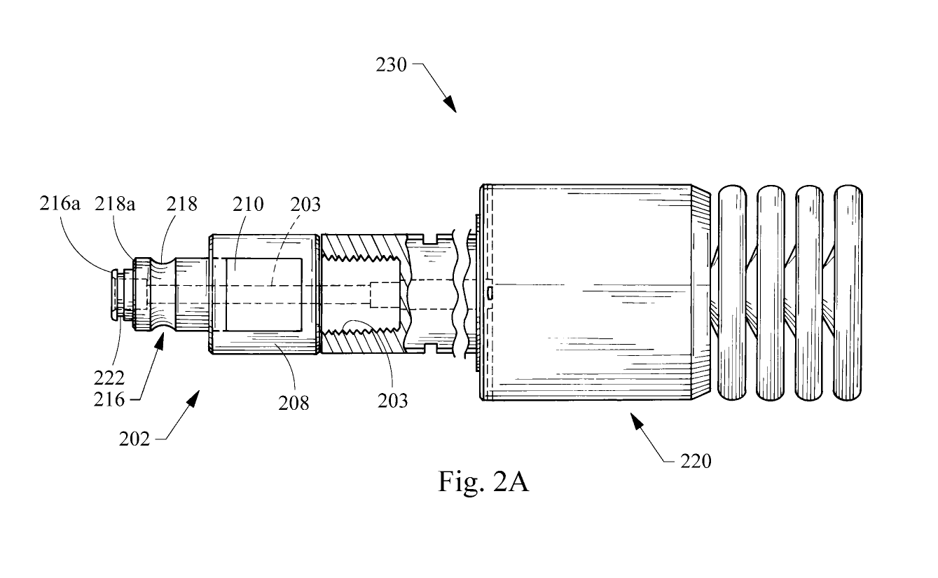

FIG. 2 shows a mandrel-connector 200 of the present invention, with its male-male mandrel-end portion 202 separated from its female-female machine-end portion 204, and from a mandrel 220. Those of skill in the art will appreciate that the connecting ends of each of these end portions may easily be reversed (e.g., one or both of the mandrel-end portion 202 and the machine-end portion 204 could be configured as female-male, and other variations that will be apparent to one of skill in the art), and that embodiments including such a feature are within the scope of the present invention. A mandrel for use within the scope of the present invention may include, for example, a mandrel such as is described in U.S. Pat. No. 6,155,091, which is incorporated herein by reference, or other mandrels known and used in the art—or developed in the future—for tube-bending or other metalworking applications. Similarly, a bender for use within the scope of the present invention may include, for example, any hydraulic, electric, hybrid, or other tube-bender known and used in the art—or developed in the future—for tube-bending or other metalworking applications (including, for example, AddisonMcKee DataBend, PowerBend, and ElbowBend draw bending machines, Baileigh Industrial MB and NCB series mandrel benders).

In the illustrated embodiment, the mandrel-end portion 202 is generally cylindrical and may include a central longitudinal lumen 203. This lumen 203, when present, allows for passage of lubricant through a central lumen of a mandrel such as, for example, the mandrel 220. The distal end portion includes a male threaded member 206. The male-threaded member 206 preferably is configured to mate engagingly with a complementary threaded surface 222 of the mandrel 220 (which is shown in a proximal projecting column, but which may be included inside the main mandrel body in other mandrel embodiments appropriate for use within the scope of the present invention). A central body portion 208 includes a larger outer diameter. As shown in the illustrated embodiment, the body portion 208 of the mandrel-end portion 202 may include an opposing pair of flattened indents 210 configured to be grasped by a wrench (not shown). These indents 210 provide for ease of use of a wrench when threadedly mounting the mandrel-end portion 202 to the mandrel 220.

A proximal end of the central body portion 208 may include a rotational locking means embodied as one or more rounded depressions 214 that are configured to engage corresponding locking tabs 252 projecting distally from the machine-end portion 204 in an embodiment where it is desirable for the mandrel 220 not to rotate relative to the machine-end portion 204 (and/or a mandrel-mount shaft, not shown). The tabs 252 and depressions 214 may be absent in an embodiment where it is desirable to allow the mandrel-end portion 202 to rotate about its longitudinal axis relative to the machine-end portion 204. Alternatively, the distal cavity 257 of the machine-end portion 204 and the proximal engagement region 216 of the mandrel-end portion 202 may have complementary geometric shapes configured to prevent relative rotation between the portions 202, 204. As such, a rotational locking means may be configured, for example, as male (projecting element) and female (receiving element) components having square, rhomboid, or hexagonal cross-sectional profiles, or having complementary three-dimensional geometries such as right-prisms, or any functional combination thereof such as, for example, a male component with a rectangular cross-sectional profile configured to engage a female component with a cavity having an octagonal cross-section, or a male component having a frustopyramidal shape configured to engage a female component with a tetrahedral cavity). Those of skill in the art will appreciate that other geometries may be practiced within the scope of the present invention.

A proximal engagement region 216 of the mandrel-end portion 202 has a smaller diameter than the central body portion 208. The proximal engagement region 216 includes a rounded detent groove 218, and a proximal lip of the proximal engagement region 216 may include an angled surface 216a. Adjacent the proximal end of proximal engagement region 216, it may also include an o-ring groove 222 configured for holding an o-ring (not shown). In one embodiment, the lumen 203 of the mandrel-end portion 202 may include a check valve (not shown) configured to be held open when the mandrel-end portion 202 is connected with a machine-end portion 204, and to close upon disconnecting those components 202, 204. Those of skill in the art will appreciate that, in this manner, lubricant in the lumen 203 and an attached mandrel can be kept from leaking out the proximal end during removal and transport of an assembled mandrel 220 and mandrel-end portion 202. It is contemplated that a connection between the mandrel-end and machine-end portions 202, 204 will generally retain a viscous fluid such as a grease-type lubricant, but will not provide a connection sufficient to provide patent fluid communication for a less viscous fluid (e.g., low viscosity oil, water).

In a preferred system of the present invention, a mandrel-end portion 202 may be mounted to each of a plurality of mandrels that is configured to be used with a bending machine. In this manner, the mandrel-end portion 202 only needs to be connected to a corresponding mandrel one time, and thereafter the combined mandrel and mandrel-end portion can be used, for example, as a single quick-exchangeable mandrel unit 230 as shown in FIG. 2A. With such a configuration, each of a plurality of mandrel units 230 may quickly and easily be exchanged from a bending machine equipped with a corresponding machine-end portion 204.

As shown in FIG. 2, the machine-end portion 204 includes an outer sleeve 240 disposed around a body core 250. In a preferred embodiment, the outer sleeve includes a textured exterior surface (such as, for example, a knurled surface) configured to provide improved friction for being grasped by an operator.

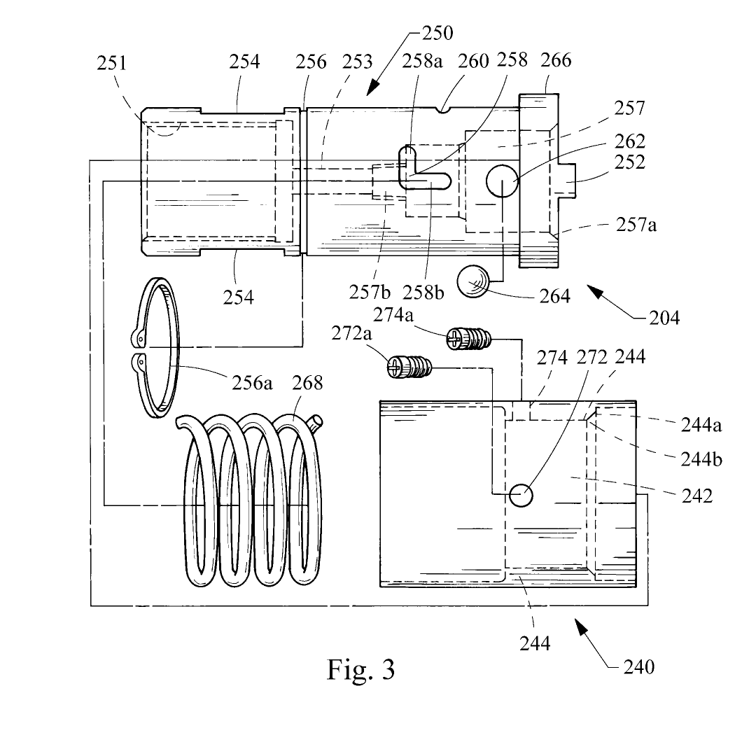

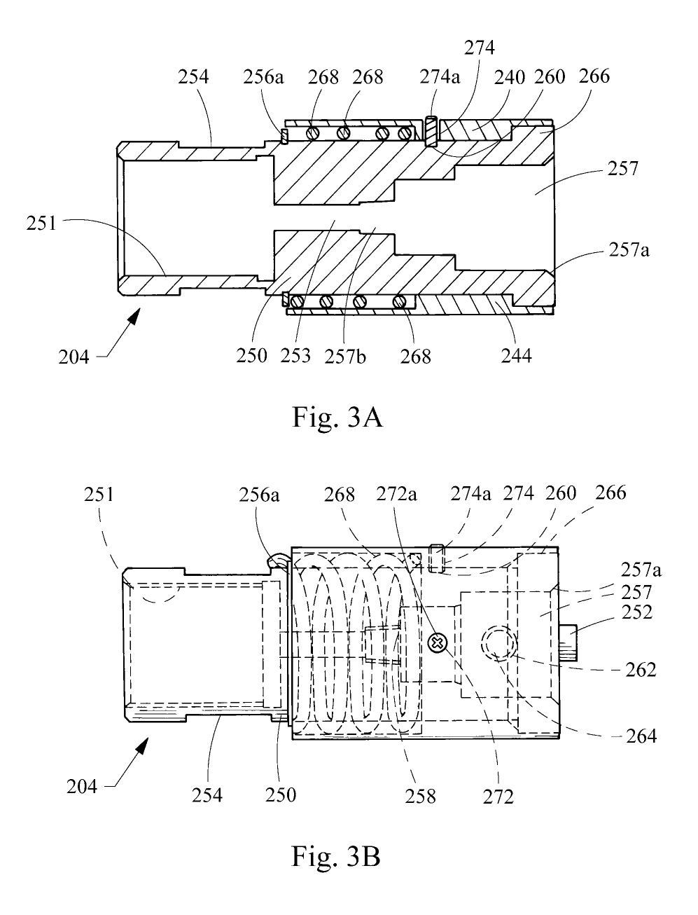

FIG. 3 shows an exploded view of the machine-end portion 204, FIG. 3A shows a longitudinal cross-sectional view of an assembled machine-end portion 204, and FIG. 3B shows a side view of an assembled machine-end portion 204. The body core 250 is generally cylindrical and may include a central longitudinal lumen 253.

In one embodiment, the lumen 253 of the machine-end portion 204 may include a check valve (not shown) configured to be held open and in alignment with the lumen 203 of the mandrel-end portion 202 when the machine-end portion 204 is connected with a mandrel-end portion 202, and to close upon disconnecting those components 202, 204. In this manner, lubricant may travel through the lumen when the components are assembled, but be prevented from leaking out when they are disconnected. A proximal outer region may include an opposing pair of flattened indents 254 configured to be grasped by a wrench (not shown) during attachment or removal of the machine-end portion 204 from a mandrel-mount shaft (not shown). A proximal portion of the body core 250 includes a female-threaded surface 251 that is configured to receive a complementarily threaded surface of a mandrel-mount shaft (not shown). Distal of and adjacent to the indents 254, the body core 250 includes a circumferential groove 256 configured to hold a retaining clamp-ring 256a. Distal of the groove 256, the body core 250 may include an L-shaped sleeve-retention groove 258 and/or a sleeve-locking indent 260. The function of the groove 258 is discussed in greater detail below.

A distal portion of the body core 250 includes a cavity 257 that is configured to receive the proximal engagement region 216 of the mandrel-end portion 202. Near the distal end of the body core 250, a plurality of open channels 262 extend from the core cavity 257 to the core exterior. Each of the channels 262 is configured to hold a ball detent 264, each preferably having an outer diameter less than but nearly equal to an inner diameter of its corresponding channel 262. As such, it is preferable that the inner/cavity-end of each channel 262 includes an inner diameter that is at least slightly less than the outer diameter of a corresponding ball detent 264. In this manner, the channel 262 will be configured to prevent a ball detent 264 from exiting the channel into the core cavity 257. Those of skill in the art will appreciate that a single detent member or a plurality of detent members may be used within the scope of the present invention. Those of skill in the art will also appreciate that a non-spherical detent component may be used together with, or in lieu of a ball detent. For example, a detent member may be provided that is generally columnar with rounded or tapered ends, or that has a different geometry configured to be advanced by the outer sleeve into engagement with the detent groove. A collar 266 having a diameter that preferably is greater than the body core outer diameter is disposed distal of and adjacent to the channels 262.

As described above, the distal end of the body core 250 of the machine-end portion 204 may include a pair of distally-projecting locking tabs 252 configured to engage the rounded depressions 214 of the central body portion 208 in embodiments where it is desirable to limit relative rotation of the machine-end and mandrel-end portions 202, 204. In the illustrated embodiment, the distal end of the core cavity 257 includes a circumferential angled surface 257a that preferably is configured to aid connective alignment with the proximal region 216 of the mandrel-end portion 202. The distal end portion 257b of the cavity 257 preferably is dimensioned to closely receive the proximal region 216 of the mandrel-end portion 202. An o-ring or other sealing means may be used to provide a seal between the proximal region 216 of the mandrel-end portion 202 and the cavity 257, thereby providing a substantially patent longitudinal lubricant passage that is generally continuous between the machine-end and mandrel-end portions 202, 204.

The ball detents 264 preferably are configured to engage the rounded detent groove 218 when the machine-end and mandrel-end portions 202, 204 are engaged, preferably such that they (204, 206) will not move longitudinally relative to each other when engaged. The ball detents 264 are retained in the channels 262 from the outside by the outer sleeve 240.

The outer sleeve 240 is generally cylindrical with a sleeve lumen 242, the distal end of which preferably is dimensioned to fit closely around the collar 266 of the body core 250, and a central portion of which is dimensioned to fit closely/slidingly around the central region of the body core 250. A sleeve collar 244 is disposed near the distal end of the outer sleeve 240. As shown in FIG. 3A, the sleeve collar 244 includes a generally flat distal collar-contact surface 244a and an angled ball detent-contact surface 244b. The collar-contact surface 244a is configured to contact the proximal surface of the body core collar 266 in a manner that preferably prevents the outer sleeve 240 from moving beyond the distal end of the body core 250. The angled ball detent-contact surface 244b is configured to contact the detent balls 264. The outer sleeve 240 and body core 250 preferably are configured such that, when a smaller inner diameter portion of the angled ball detent-contact surface 244b contacts the detent balls 264, they (264) are advanced into the channels 262 and protrude into the cavity 257 such that they (264) may engage the rounded detent groove 218 of the mandrel-end portion 204.

In the illustrated embodiment, the outer sleeve 240 may be locked into an open or a closed configuration. As shown in the illustrated embodiment, a biasing means embodied as a compressed coil spring 268 may be disposed between the clamp-ring 256a and the sleeve collar 244 such that the sleeve collar 244 is distally biased. In an alternative embodiment, a plurality of set screws (not shown) may protrude into the sleeve lumen 242 in a manner configured to retain the coil spring 268 or an equivalent biasing means such as, for example, another spring type, an elastomeric material, or a pneumatic biasing means.

A first set screw 272a mounted in a first aperture 272 of the outer sleeve 240 may be configured to ride slidingly in the L-shaped groove 258 to form a bayonet-style locking mechanism. Specifically, the outer sleeve 240 may be locked into an open configuration by being moved proximally (against the bias of the spring 268) and rotated partially about the longitudinal axis such that the first set screw 272a will be captured in the transverse lower leg 258a of the L-shaped groove 258. In a default closed configuration, the first set screw 272a may ride up to the distal end of the longitudinal upper leg 258b of the L-shaped groove 258, which position preferably coincides with the closed configuration contact of the outer sleeve collar 244 with the body core collar 266. When the sleeve 240 is in a closed position, a second set screw 274a (or a plurality of the same) may be mounted in a second aperture 274 and may be engaged to lock into the sleeve-locking indent 260 to keep the sleeve 244 in position, which—in turn—locks the machine-end and mandrel-end portions 202, 204 longitudinally together as the detent balls 266 are locked into the rounded detent groove 218.

The ability to lock the outer sleeve 244 into an open or closed configuration provides time-saving and motion-saving advantages as well as security of engagement (when the sleeve is closed, as when mounting a mandrel to a bending machine using a connector of the present invention). Most preferably, a generally transverse portion of the sleeve-retention groove (such as, for example, the lower leg 258a or another suitably-dimensioned capture region) will include at least a portion that is disposed at an angle of 90° or less relative to the longitudinal portion of the groove (such as, for example, the upper leg 258b) at its proximal end. Those of skill in the art will appreciate that the sleeve-retention groove 258 and indent 260 may each have a geometry different than that illustrated, within the scope of the present invention. For example, the sleeve-retention groove may be U-shaped, J-shaped, V-shaped, or configured with another shape that will provide for holding the sleeve in a retracted position. With this configuration, the bias of the sleeve will hold it in a retracted position when a pin member (such as, for example, the first set screw 272a) is engaged with the transverse groove portion. Those of skill in the art will also appreciate that a second capture region may be disposed opposite the first capture region (e.g., 258a) such that the pin member may be captured at the opposite end of the groove (for example, by a Z-shape, S-shape, or traditional bayonet-grooved shape). Each of the device components preferably is constructed from stainless steel or a similarly durable metal or alloy that can be accurately tooled within the tolerances most preferable for the close fit of components described herein and to be appreciated by those of skill in the art.

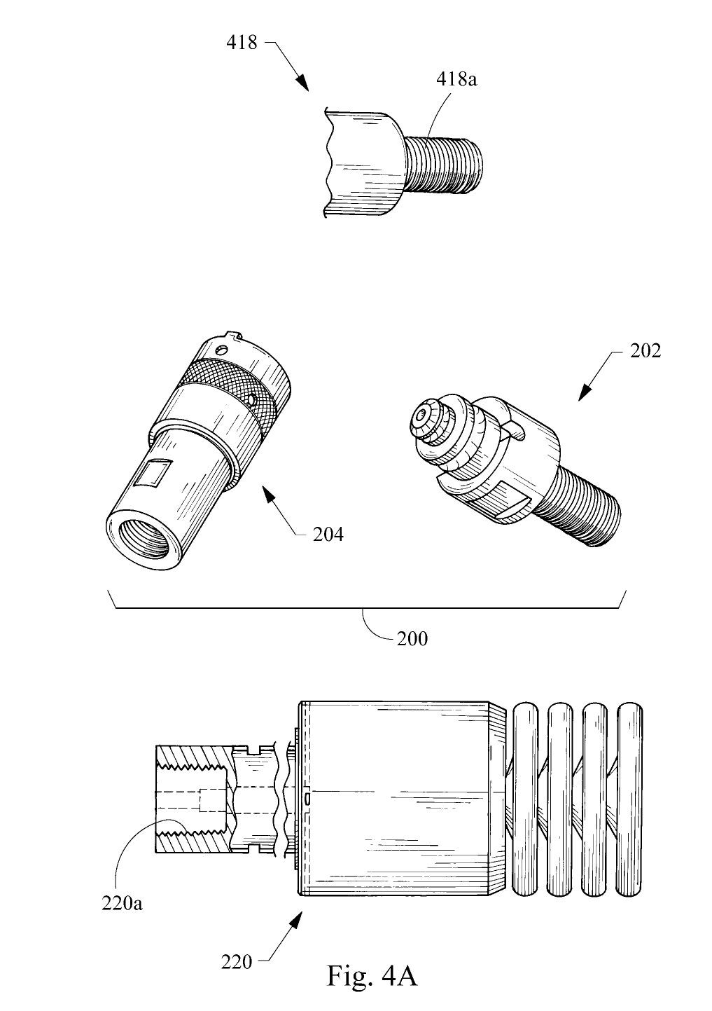

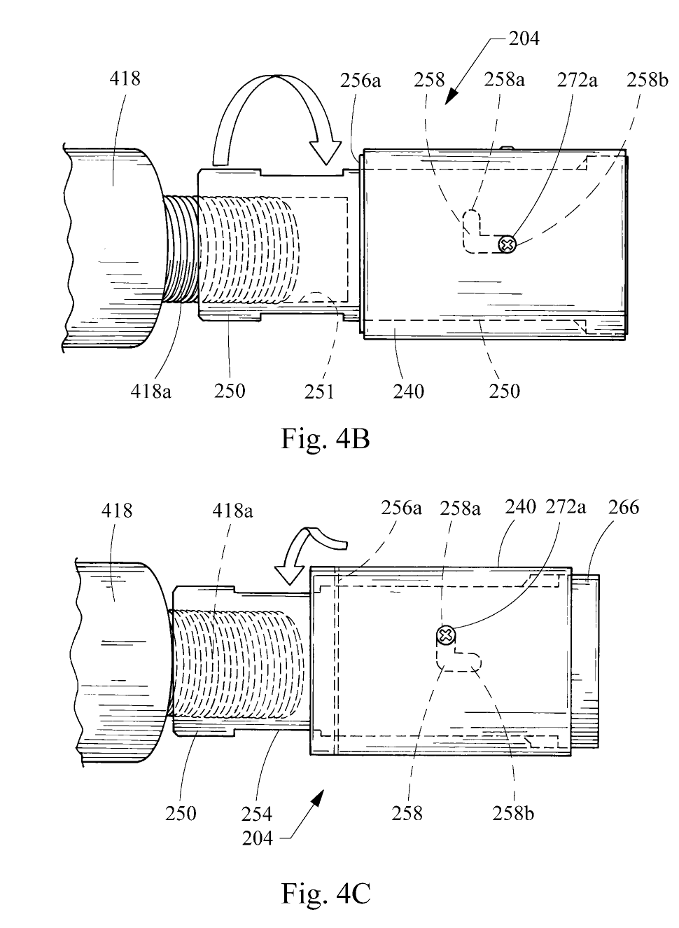

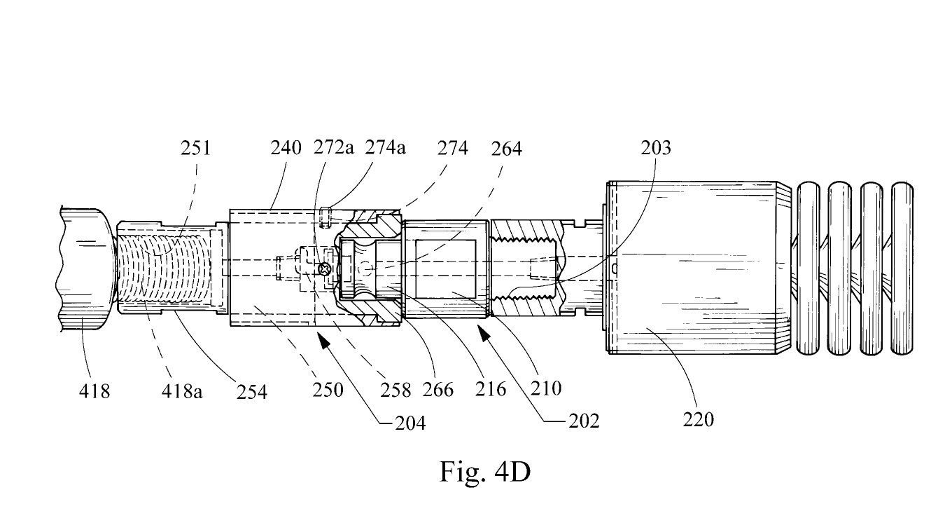

A method of using a mandrel-connector 200 is illustrated in FIGS. 4A-4D with reference to FIGS. 2-3B. As shown in FIG. 4A, a mandrel-mount shaft 418 of a bending machine (not shown) and a mandrel 220 are provided. As illustrated, the mandrel-mount shaft 418 includes a distal male-threaded surface 418a, and the mandrel 220 includes a proximal female-threaded surface 220a. Those of skill in the art will appreciate that the maleness/femaleness of these components may be reversed, with corresponding changes in the components of the mandrel-connector described below.

As shown in FIG. 4B, a wrench (not shown) may be engaged with the flattened indents 254 and used to threadedly mount the female-threaded surface 251 of the machine-end portion 204 onto the distal male-threaded surface 418a of the mandrel-mount shaft 418. A wrench (not shown) may also be used to threadedly mount the distal male-threaded surface 206 of the mandrel-end portion 202 into the female-threaded surface 220a of the mandrel 220 (see FIG. 2A). In a highly preferred aspect of the present invention, each bending machine is provided with an installed machine-end portion, and each mandrel is provided with an installed mandrel-end portion such that a plurality of mandrels may interchangeably be used with a plurality of bending machines using a quick-exchange method of the present invention. In this manner, the installation of machine-end portions and mandrel-end portions need only be done once for each respective bending machine and mandrel.

As shown in FIG. 4C, in a preferred aspect of the method, the outer sleeve 240 of the machine-end portion 204 is held in a retracted position to provide for connection with the mandrel-end portion 202. This may be accomplished by drawing the outer sleeve 240 proximally against the bias of the coil spring 268, and rotating it (240) about the longitudinal axis such that the first set screw 272a tracks through the sleeve-retention groove 258 and is biasedly captured in its transverse lower leg 258a, which functions as a first capture region. Alternatively, an operator can manually retract the sleeve 240 and hold it in place. With the sleeve 240 retracted, the detent balls 264 can move freely in their respective channels 262.

As shown in FIG. 2A, the mandrel 106 can be mounted to the mandrel-mount shaft 418. The proximal end of the mandrel-end portion 204 (attached to the mandrel 106) is directed into the distal end of the cavity 257 of the machine-end portion 202. As the proximal end of the mandrel-end portion 204 passes the detent balls 264, their protruding portions will be dislodged from the cavity 257. Then, when the rounded detent groove 218 is aligned in a coplanar manner with the detent balls 264, they (264) can protrude from their channels to engage the groove 218. When the mandrel end portion is fully engaged, its proximal end preferably contacts the proximal end surface of the cavity 257 of the machine-end portion 202.

Next, as shown in FIG. 4D, the sleeve 240 may be released such that it is biasedly moved into a closed configuration. In the closed configuration, the mandrel-end and machine-end portions 202, 204 most preferably are connected in a manner that preferably allows virtually no relative longitudinal movement. Accordingly, in preferred embodiments, the proximal end of the mandrel-end portion 204 contacts the proximal end surface of the cavity 257 of the machine-end portion 202, and the detent balls 264 mate tightly with the detent groove 218. The detent balls 264 are moved into—and held in—engagement with the detent groove 218 by the inner surface of the sleeve 240. As also shown in FIG. 4D, the sleeve 240 may be locked into a closed configuration by engaging the second set screw 274a (mounted in the second aperture 274) into the sleeve-locking indent 260 to keep the sleeve 244 in position. This engagement will help to locks the machine-end and mandrel-end portions 202, 204 longitudinally together as the detent balls 266 are locked into the rounded detent groove 218 by the sleeve 240. In addition, this engagement helps minimize the likelihood that the sleeve 240 may inadvertently be retracted, for example, during an operation, which would be undesirable as it would release the mandrel-end portion 204.

The embodiment shown in FIGS. 4A-4D is shown without a locking tab arrangement (mating tabs 252 and depressions 214) as shown in FIG. 2, and so is configured to allow the mandrel-end portion 204 to rotate about its longitudinal axis relative to the machine-end portion 202. In order to replace the mandrel 106 with a different mandrel, an operator may reverse the steps shown in FIGS. 4B-4D, and then repeat the steps with the different mandrel. Note: for the sake of drawing clarity, certain features, including—for example—a biasing means and certain threaded surface contours, may not be shown in some figures, but those omissions do not limit the scope of the present invention.

Those of skill in the art will appreciate that variations of the embodiments described above may be practiced within the scope of the present invention. For example, one of skill in the art will appreciate that an embodiment having a sleeve and biasing means reversed from that described above (e.g., wherein the sleeve is biased proximally in a manner that engages the detent means, and must be moved and/or retained distally to release the detent means) may be practiced within the scope of the present invention. It is therefore intended that the foregoing detailed description be regarded as illustrative rather than limiting. It should be understood that the following claims, including all equivalents, are intended to define the spirit and scope of this invention.

I claim:

1. A quick-connector device configured for use in connecting a mandrel with a metal-working machine, said device comprising:
a first portion configured for connection to a selected one of a mandrel and a metal-working machine;
a second portion configured for connection to the other of the mandrel and the metal-working machine;
wherein the first portion comprises
a generally cylindrical first body including a first threaded surface configured for threadedly engaging the selected one of the mandrel and the metal-working machine and
a detent-grooved projection at an end of the first body that is opposite the first threaded surface, said detent-grooved projection comprising a generally circumferential detent groove; and
wherein the second portion comprises
a generally cylindrical second body including a second threaded surface configured for threadedly engaging the other of the mandrel and the metal-working machine;
a tubular sleeve slidably disposed about the second body;
said sleeve having a first inner circumferential portion and a second inner circumferential portion;
wherein the first inner circumferential portion has a greater diameter than the second inner circumferential portion and is longitudinally adjacent thereto;
said sleeve being biased toward the second inner circumferential portion;
said cylindrical second body also comprising a retention groove, at least a portion of said groove being transverse to a longitudinal axis of the cylindrical second body;
said tubular sleeve comprising a pin member protruding therefrom and slidably engaging the retention groove;
a cavity in the cylindrical second body end that is opposite the second threaded surface, said cavity being dimensioned to receive the detent-grooved projection;
at least one detent channel open between the sleeve and the cavity;
a detent member disposed movably in the at least one detent channel and dimensioned such that the detent member protrudes into the cavity when contacted by the sleeve.

2. The quick-connector device of claim 1, further comprising a first lumen portion disposed longitudinally through the first quick-connector device portion and a second lumen portion disposed longitudinally through the second quick-connector device portion, wherein said first and second lumen portions are configured to form a continuous lumen when the first quick-connector device portion and second quick-connector device portion are engaged.

3. The quick-connector device of claim 1, further comprising a sleeve-lock mechanism comprising:
a locking member disposed retractably through the sleeve and an indent disposed on an exterior surface of the cylindrical second body;
wherein, an engagement of the locking member with the indent prevents movement of the sleeve relative to the cylindrical second body.

4. The quick-connector device of claim 1, wherein the retention groove comprises a generally longitudinal groove portion and a generally transverse groove portion disposed at an angle relative to the longitudinal groove portion.

5. The quick-connector device of claim 4, wherein the generally longitudinal groove portion has a first end disposed nearer the second threaded surface and at least part of the generally transverse groove portion is disposed adjacent that first end at an angle of 90° or less, relative to the longitudinal groove portion.

6. The quick-connector device of claim 1, further comprising a rotational locking means.

7. The quick-connector device of claim 6, wherein the rotational locking means comprises:
a projecting element disposed on one of the first or second quick-connector device portions; and
a receiving element disposed on the other of the first or second quick-connector device portions;
wherein the projecting element is configured to engage with the receiving element.

8. The quick-connector device of claim 7, wherein the projecting element comprises a longitudinally extending tab member and the receiving element comprises a depressed surface.

9. The quick-connector device of claim 1, wherein at least one detent member surface is configured to fit engagingly with a portion of the detent groove.

10. The quick-connector device of claim 1, wherein the detent-grooved projection and the cavity are dimensioned such that when the detent-grooved projection engages the cavity, the detent member is aligned with the detent groove.

11. The quick-connector device of claim 1,
wherein the detent-grooved projection and the cavity are dimensioned such that when the detent-grooved projection engages the cavity, the detent member is aligned with the detent groove;
wherein, when the sleeve is moved such that its circumferential inner portion contacts the detent member, the detent member is engaged with the detent groove; and
the engagement of the detent member with the detent groove substantially prevents relative longitudinal movement of the first and second quick-connector device portions.

12. The quick-connector device of claim 1, wherein the sleeve being biased toward an end thereof that is opposite the second threaded surface is biased by a coil spring held in place around the second body.

13. The quick-connector device of claim 1, wherein the detent channel comprises a circular cross-section.

14. The quick-connector device of claim 1, wherein the detent member comprises a circular cross-section.

15. The quick-connector device of claim 1, wherein the detent member comprises a generally spherical ball detent.

16. A quick-connector device comprising:
a tool-side element and a machine-side element;
wherein the tool-side element comprises a distal means for connection to a tool and a proximal means for connection to the machine-side element;
wherein the machine-side element comprises a proximal means for connection to a machine and a distal means for connection to the tool-side element;
wherein one of the distal means for connection to the tool-side element and the proximal means for connection to the machine-side element comprises a slidable, longitudinally-biased sleeve member and a means for retaining the longitudinally-biased sleeve member in a position opposing its bias.

17. The quick-connector device of claim 16,
wherein the one of the distal means for connection to the tool-side element and the proximal means for connection to the machine-side element comprises a generally cylindrical body about which the longitudinally-biased sleeve member is longitudinally slidably disposed;
wherein the means for retaining the longitudinally-biased sleeve member in a proximal position opposing its bias comprises a retention groove on an external surface of the generally cylindrical body and a projection from the sleeve member engaged with the retention groove.

18. The quick-connector device of claim 17, wherein the retention groove is generally L-shaped.

19. The quick-connector device of claim 16, wherein one of the distal means for connection to the tool-side element and the proximal means for connection to the machine-side element comprises a projection including a detent groove.

20. The quick-connector device of claim 19, wherein the other of the distal means for connection to the tool-side element and the proximal means for connection to the machine-side element comprises a distal cavity configured to receive the projection, said cavity including a detent means configured to engage the detent groove.

21. The quick-connector device of claim 16, further comprising a tool, said tool comprising a mandrel member.

22. The quick-connector device of claim 21, wherein the mandrel member comprises a generally cylindrical mandrel body and a distal semi-flexible portion connected to the generally cylindrical mandrel body.

23. The quick-connector device of claim 21, wherein the mandrel member comprises a first threaded surface, and the distal means for connection to the mandrel member comprises a second threaded surface complementary that is thereto.

24. The quick-connector device of claim 16, further comprising a machine, said machine comprising a tube bender machine.

25. The quick-connector device of claim 24, wherein the tube bender machine comprises a first threaded surface, and the proximal means of the machine-side element for connection to the tube bender machine comprises a second threaded surface that is complementary thereto.
